(19) United States
(12) Patent Application Publication
(10) Pub. No.: US 2013/0071144 A1
(43) Pub. Date: Mar. 21, 2013

(54) MULTIFUNCTIONAL CARBON POWDER FILLING DEVICE FOR REGENERATION OF CARBON POWDER CARTRIDGE

(71) Applicant: Lei Shi, Beijing (CN)

(72) Inventor: Lei Shi, Beijing (CN)

(73) Assignee: BEIJING LASER HI-TECH. CO., LTD., Beijing (CN)

(21) Appl. No.: 13/520,292

(22) PCT Filed: May 16, 2011
(86) PCT No.: PCT/CN11/74088

§ 371 Date: Jul. 2, 2012

(30) Foreign Application Priority Data
Dec. 8, 2010 (CN) 201010577451.3

(51) Int. Cl. G03G 13/08

(52) U.S. Cl. CPC G03G 13/08
USPC 399/258

(57) ABSTRACT

A multifunctional ink powder filling device for a regenerated powder cartridge box, which includes a bottle body, a powder-leakage prevention bottle plug, a powder filling nozzle and a bottle cover serving as a measuring cup at the same time, wherein the bottle plug is tightly matched and arranged on a bottle mouth of the bottle body and is externally provided with the powder filling nozzle, the inner and the outer peripheries of the pedestal of the powder filling nozzle are respectively provided with inner threads matched with the outer threads of the bottle mouth and outer threads matched with the inner threads on the mouth part of the bottle cover, and the upper end of the powder filling nozzle is provided with a diminishing heavy-caliber powder filling hopper.

### TECHNICAL FIELD

The present invention relates to a powder filling device for regenerated powder cartridge box, which is used for powder filling of regenerated powder cartridge box of laser printer, copier, digital stencil duplicator, etc.

### BACKGROUND OF THE TECHNOLOGY

The powder filling of traditional powder cartridge box comprises opening the powder cartridge box which is exhausted with ink powder, filling the powder cartridge box through powder filling nozzle with bottled ink powder of corresponding type, sealing the powder cartridge box for use of the next time. Generally, in this kind of powder filling device, each bottle of powder corresponds to single type of powder cartridge box; and the amount of the powder in the bottle can only afford filling the powder cartridge box 1˜2 times. The filling device has to be abandoned after one time of powder filling. This is because the powder filling amount of every powder cartridge box is fixed; if the powder cartridge box is filled too much, the stirring device inside the powder cartridge box will suffer too much strength and the rotation will be influenced, even ‘locked’ so as to stop work. Besides, when the waste powder storage for collecting waste powder is fully filled, the printing effect will be seriously influenced. If the redundant ink powder is left in the bottle, it cannot be sealed strictly after opened and will be abandoned for caking. If the amount of powder filling is less than the allowable powder filling amount of the powder cartridge box, the amount of the print production of the powder cartridge box after regeneration cannot be insured. Therefore, filling powder quantitatively is a basic demand for generation of powder cartridge box, and each powder filling bottle generally used in the market has to be thrown away after one time of quantitative powder filling, resulting in environment pollution and waste.

Ink powder with large packages sold in the market are mostly packaged in moisture-proof plastic bag. The ink powder used in powder cartridge box can float following the flow of air for the small weight and tiny granularity, and very good fluidity. Because of the large packaging bag, general users without special powder filling tools can not fill the powder into the powder cartridge box, and can not used by users or maintenance men in-site. Therefore, for ink powder for regeneration of powder cartridge box, special powder filling device is needed to divide the ink powder in the large package into small bottles, which directly affects the convenience of the regeneration of the powder cartridge box and deepening development of environment protecting.

### SUMMARY OF THE INVENTION

The present invention provides a multifunctional ink powder filling device for regenerated powder cartridge box, which can overcome the disadvantages of serious waste and high price caused by the fact that the filling powder can only be used once, and can change the disadvantage that large package of ink powder can not be used in in-site regeneration of powder cartridge box without special powder filling device. The powder filling amount is raised from 1˜2 powder cartridge boxes which one bottle of ink powder can fill to 7˜10 powder cartridge boxes, and the powder cartridge box can be filled for many times or many types of machines can be filled. The technical solution of the present invention comprises a bottle body, a powder-leakage prevention bottle plug, a powder filling nozzle and a bottle cover serving as a measuring cup at the same time, wherein the bottle plug is tightly matched and arranged on a bottle mouth of the bottle body and is externally provided with powder filling nozzle, the inner and the outer peripheries of the pedestal of the powder filling nozzle are respectively provided with inner threads matched with the outer threads of the bottle mouth and outer threads matched with the inner threads on the mouth part of the bottle cover, and the upper end of the powder filling nozzle is provided with a diminishing heavy-caliber powder filling hopper.

A light-caliber powder filling hopper is plugged in or connected through threads with the heavy-caliber powder filling hopper so as to be adapted to the needs of different powder filling nozzles of powder cartridge boxes.

The bottle cover is provided with scales serving as a measuring cup which can quantitatively measure the amount of the filled powder for different powder cartridge boxes at the time of powder filling.

Diminishing steps are provided on top of the inner threads on the mouth part of the bottle cover to be tightly impacted on the shoulders of the pedestal of the powder filling nozzle.

The powder filling amount of the bottle body is 7˜10 times of the amount of the powder needed by general powder cartridge box, and can be used for powder filling of many powder cartridge boxes of the same type or powder cartridge boxes of different types but use ink powder with the same standard.

The bottle plug comprises cylindric upright side and bottom, wherein the upper end of the cylindric upright side is provided with external protruding edge, the outer peripheries of the cylindric upright side are provided with several sealed protruding rings around the circle and tightly matched with the inner side of the bottle mouth.

The waist part of the bottle body is provided with grooves to be convenient for holding.

The advantages of the present invention are: the powder filling amount is raised from 1˜2 powder cartridge boxes which one bottle of ink powder can fill to 7˜10 powder cartridge boxes; the ink powder used for regeneration of powder cartridge box is filled in the bottle body; the bottle cover of the bottle body serves as a measuring cup at the same time and quantitatively powder filling can be carried on for different types of powder cartridge box; the inner part of the bottle cover is provided with powder filling nozzle and the size of the powder filling nozzle can be changed to adapt to the need of the powder filling nozzle of powder cartridge box with different sizes. The bottle plug is used to seal the residual ink powder after each time of powder filling to prevent environment pollution caused by leakage of ink powder and caking caused by moisture, so as to insure the use is not influenced.

Larger volume makes it possible that the powder cartridge box can be filled powder for many times and the price of ink powder each powder cartridge box used is lower. Multifunction and being easy to carry and use provides convenience for in-site powder filling of powder cartridge box by personnel.

Since general ink powder may correspond to powder cartridge boxes of machines of many types, great convenience is provide to offices and companies with machines of many types or maintenance men for regeneration of powder cartridge box.

### DESCRIPTION OF THE DRAWINGS

FIG. 1 is the sectional view of the general assembly structure of the present invention;

FIG. 2 is the schematic drawing of the parted structure of the present invention;

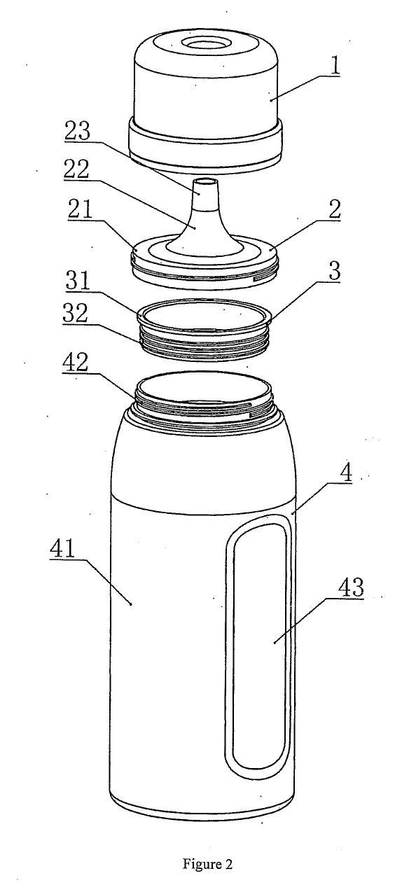

FIG. 3 is the schematic drawing of the shape of the bottle body of the present invention;

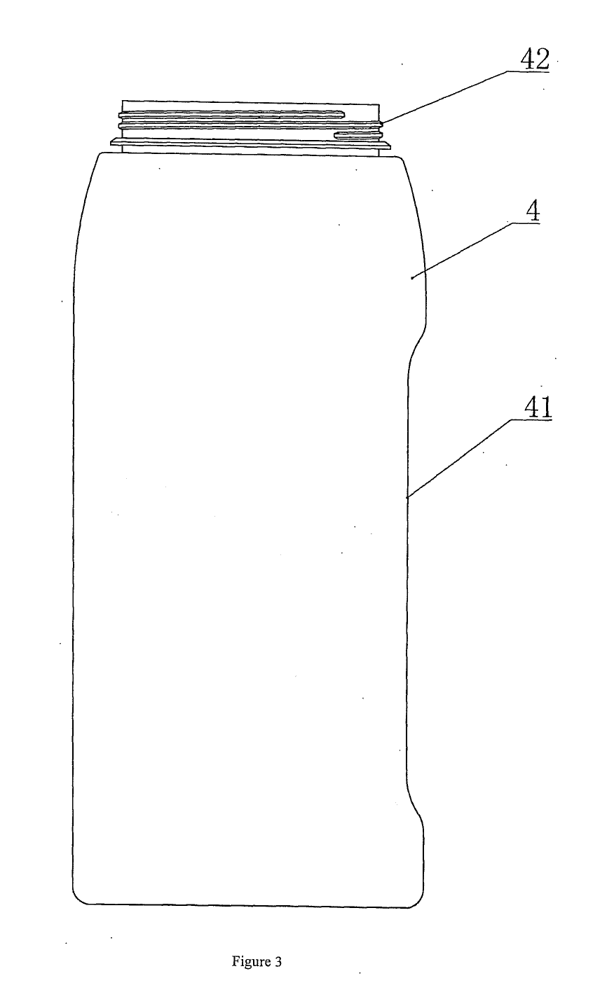

FIG. 4 is the axial sectional view of the bottle plug of the present invention;

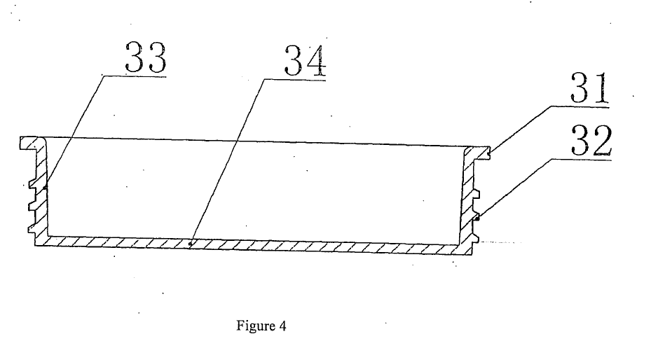

FIG. 5 is the top view of FIG. 4;

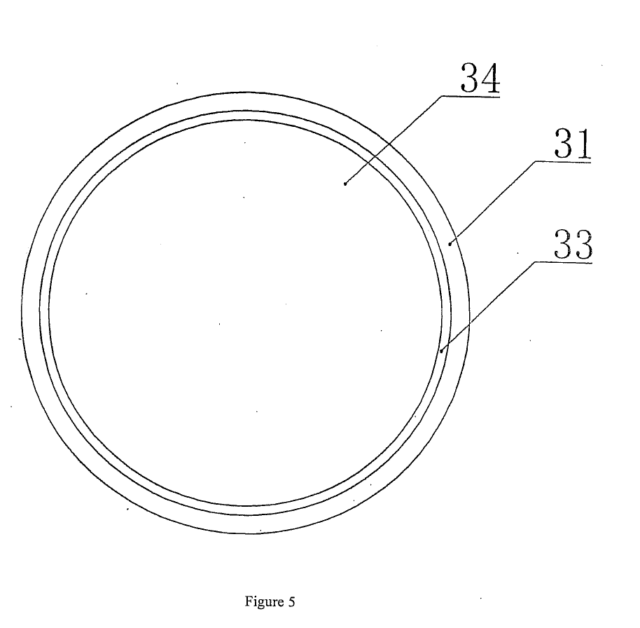

FIG. 6 is the axial sectional view of the powder filling nozzle of the present invention;

FIG. 7 is the top view of FIG. 6;

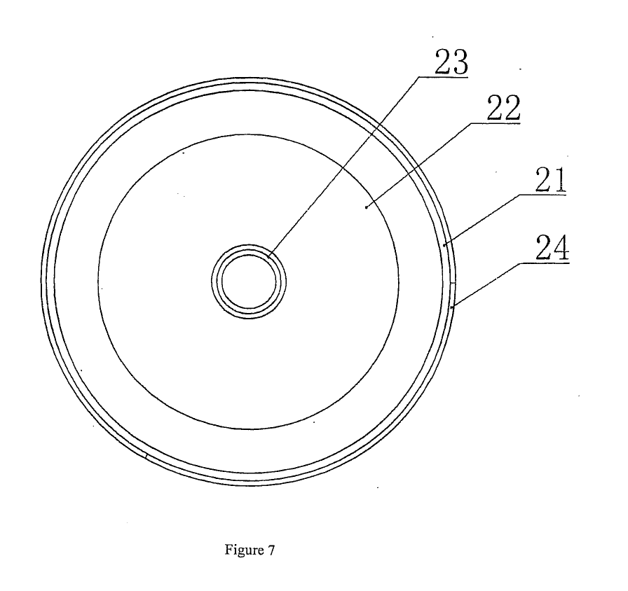

FIG. 8 is the axial sectional view of the bottle cover of the present invention;

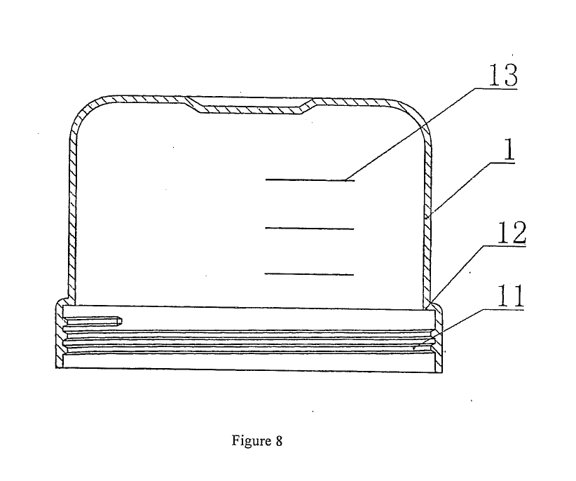

FIG. 9 is the upward view of FIG. 8;

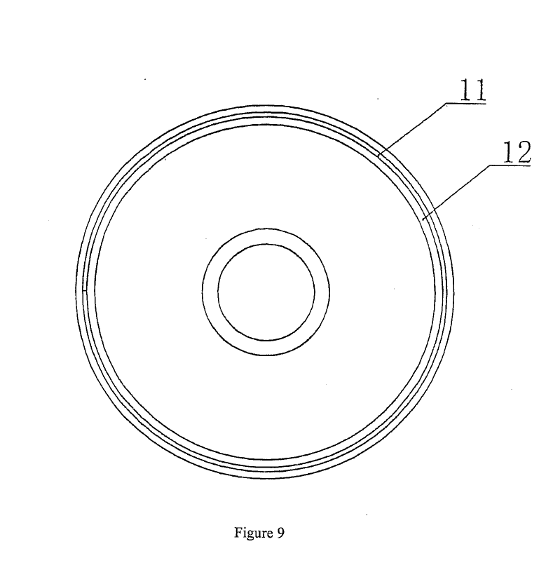

FIG. 10 is the schematic drawing of one use combination of the present invention;

FIG. 11 is the schematic drawing of another use combination of the present invention.

### SPECIFIC METHOD OF USE

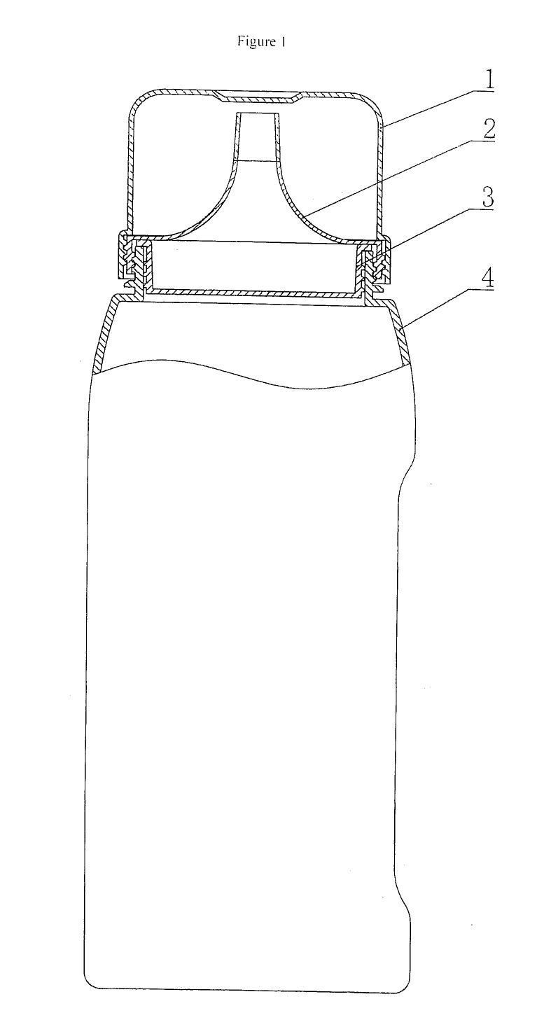

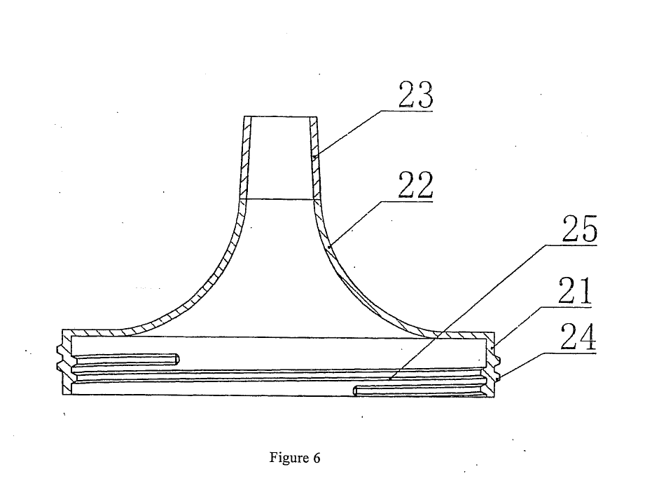

According to FIGS. 1˜9, the example of the present invention comprises a bottle body 4, a powder-leakage prevention bottle plug 3, a powder filling nozzle 2 and a bottle cover 1 serving as a measuring cup at the same time, wherein the bottle plug 3 is tightly matched and arranged on a bottle mouth of the bottle body 4, and is externally provided with powder filling nozzle 2, the inner and the outer peripheries of the pedestal 21 of the powder filling nozzle 2 are respectively provided with inner threads 25 matched with the outer threads 42 of the bottle mouth and outer threads 24 matched with the inner threads 11 on the mouth part of the bottle cover 1 (see FIG. 6), and the upper end of the powder filling nozzle 2 is provided with a diminishing heavy-caliber powder filling hopper 22 (see FIG. 6).

A light-caliber powder filling hopper 23 may also be plugged in or connected through threads with the heavy-caliber powder filling hopper 22 (see FIG. 6), so as to be adapted to the needs of different powder filling nozzles of powder cartridge boxes.

The bottle cover 1 is provided with scales 13 serving as a measuring cup which can quantitatively measure the amount of the filled powder for different powder cartridge boxes at the time of powder filling.

Diminishing steps 12 are provided on top of the inner threads 11 on the mouth part of the bottle cover 1 to be tightly impacted on the shoulders of the pedestal 21 of the powder filling nozzle.

The powder filling amount of the bottle body 4 is 7˜10 times of the amount of the powder needed by general powder cartridge box, and can be used for powder filling of many powder cartridge boxes of the same type or powder cartridge boxes of different types but use ink powder with the same standard.

The bottle plug 3 comprises cylindric upright side 33 and bottom 34, wherein the upper end of the cylindric upright side 33 is provided with external protruding edge 31, the outer peripheries of the cylindric upright side 33 are provided with several sealed protruding rings 32 around the circle and tightly matched with the inner side of the bottle mouth of the bottle body 4, and the elastic deformation of the sealed protruding rings 32 is used to promote the sealing performance.

The waist part of the bottle body 4 is provided with grooves 41 to be convenient for holding.

The bottle body 4 of the present invention is filled with different amounts of ink powder according to different amounts of powder needed by the powder cartridge box, and the amount of filled ink powder is sufficient to fill 7˜10 times/each different powder cartridge box. In one example, the amounts of filled powder in the bottle, the types of the powder cartridge boxes and the times of filling powder can be seen in table 1.

Since some ink powder may correspond to powder cartridge boxes of machines of many types, great convenience is provide to offices and companies with machines of many types or maintenance men for regeneration of powder cartridge box. In table 1, the machine types of powder cartridge boxes that each bottle of ink powder can adapt to are indicated.

The bottle body is provided with grooves 41 to be convenient for personnel who regenerate the powder cartridge box to hold the bottle body; labels and information about ink powder, adapted machine types and the product can be attached to the grooves.

The mouth of the bottle body is provided with bottle plug 3, which is used to seal the residual ink powder after ink powder filling and using every time, to prevent moisture and powder-leakage.

The powder filling nozzle 2 is directly screwed down on the mouth of the bottle, and the heavy-caliber and light-caliber powder filling hopper 22 and 23 on the upper end of the powder filling nozzle 2 increase the threads connection (or plugging connection); when heavier-caliber powder cartridge box is filled with ink powder, the light-caliber powder filling hopper 23 on the upper end of the powder filling nozzle should be screwed off and the heavy-caliber powder filling hopper 22 should be used for powder filling of powder cartridge box to improve working speed and efficiency.

Since the powder cartridge box needs to be filled quantitatively, scale 13 for gram weights of carbon powder is marked on the bottle cover 1 of the present invention to indicate the amount of ink powder needed by each powder cartridge box according to different types, so as to fill the powder cartridge box quantitatively.

The using method of the present invention comprises:

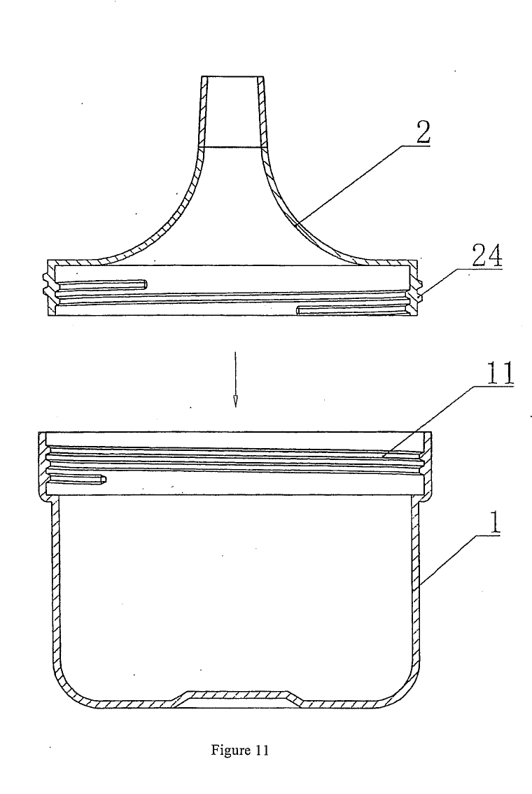

when filling powder cartridge box with ink powder for regeneration, opening the bottle cover 1 in FIG. 1, screwing off the powder filling nozzle 2, pulling out the bottle plug 3, pouring the ink powder in the bottle into the bottle cover (the measuring cup) 1 according to the amount of powder needed by different types of powder cartridge box, screwing down the powder filling nozzle 2 in the inner part of the bottle cover 1 (as shown in FIG. 11), selecting powder filling nozzle 2 with suitable caliber according to the size of powder filling hole of the powder cartridge box, and then filling the powder cartridge box with powder in turns.

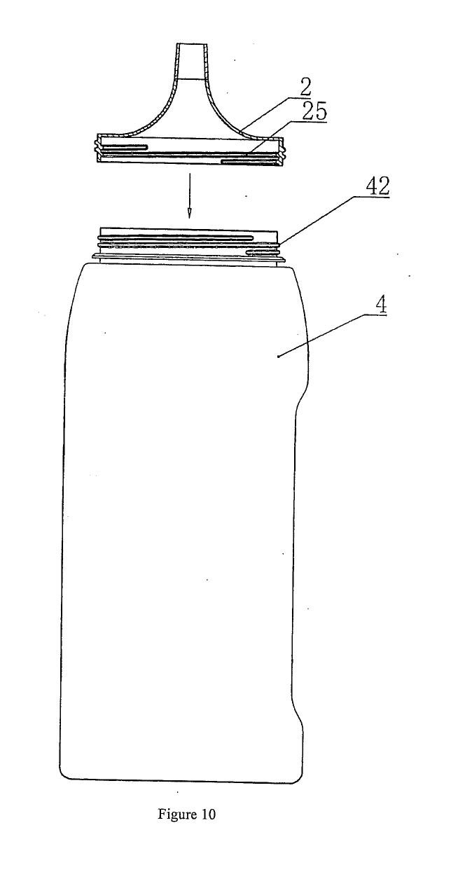

If residual ink powder is left in the bottle after powder filling each time, the bottle plug 3 is needed to seal the residual ink powder; the powder filling nozzle 2 should be taken out of the measuring cup (bottle cover) 1 and screwed onto the mouth of the bottle (as shown in FIG. 10), and the bottle cover (the measuring cup) 1 should be used to seal the mouth of the bottle tightly to be ready for use next time.

It can be seen that, the present invention is characterized in that:

1. The bottle body of the present invention is used in powder filling device of large packages, and each bottle of powder can be filled into 7˜10 powder cartridge boxes; thus the price of the powder used for regeneration of powder cartridge box is brought down, because for ink powder with the same standard and the same amount, larger packages are cheaper than smaller packages. The cost of regeneration of single powder cartridge box is saved.

2. Compared with the small package wherein each bottle can only fill one powder cartridge box, the quantities of the bottle bodies and packaging materials of the large volume powder filling device of the present invention are saved, and the environment pollution caused by waste package is decreased.

3. The powder filling nozzle 2 with measuring cup (bottle cover 1) and powder cartridge box can be operated by users to fill powder themselves or by maintenance men to fill powder in-site without special tools, and great convenience is brought for regeneration of powder cartridge box.

4. With the large volume powder filling device of the present invention, one bottle of powder can be used for regeneration of many powder cartridge boxes, and also can be used for regeneration of many powder cartridge boxes of the same type at the same time.

5. The general ink powder which can be used in many machine types can be used in powder filling of powder cartridge boxes with different types at the same time. Great convenience is brought for offices and companies in need of regeneration of multi-machine powder cartridge boxes.

6. Multi-functional large-volume ink powder filling device brings convenience for personnel filling powder in-site to carry the ink powder.

7. When in-site powder filling or at the service counter is needed with large volume packages using generally used plastic bags, the problems that special powder filling tools are needed and the environment pollution caused by floating powder and excessive powder are solved.

8. The special shape of the bottle body brings convenience for holding and operating at the time of powder filling.

9. The combinational structure of the bottle body 3, the measuring cup (bottle cover 1), the powder filling nozzle 2 and the sealing bottle plug 3 provides advantages such as convenient using and easy operating, and provides convenient conditions for development of regeneration of powder cartridge box, and can promote the development of environment protection and reusing.

Table 1, comparison table of types of carbon powder/machine types of powder cartridge boxes/weights of filled powder.

| | | | Weight of | Filling |
|---|---|---|---|---|
| Types of | | Weight | each powder | ability of |
| carbon | Corresponding | of each | cartridge | each bottle |
| powder | machines | bottle(g) | box (g) | (/each time) |
| CLT-08 | HP LaserJet | 800 g | 115 g | 7 |
| | 4L/4P/4V/4SI/5Si/5L/6P/6L/1100/8000/1010/ | | | |
| | 1012/1015/1018/1020/1022/3015/3020/3030/ | | | |
| | 3050/3052/3055/M1319f/M1005MFP | | | |
| CLT-08 | CANON LBP-2900/3000 | 800 g | 115 g | 7 |
| CLT-20S | HP LaserJet | 800 g | 100 g | 8 |
| | P1005/P1006/P1007/P1008/ | | | |
| | P1505/ProP1566/Pro | | | |
| | P1606dn/M1120/M1522/Pro | | | |
| | M1136/Pro M1213nf | | | |
| CLT-20S | CANON | 800 g | 100 g | 8 |
| | LBP-3018/3108/6018/3250/ | | | |
| | 6200d | | | |
| BR-07V2 | BrotherHL-2040/2045/2070N/ | 800 g | 100 g | 8 |
| | 2075N/2140/2150N/2170W; | | | |
| | FAX-2820/2920; DCP-7010/7025/ | | | |
| | 7030/7040; | | | |
| | MFC-7220/7420/7340/7450/ | | | |
| | 7840N | | | |
| BR-07V2 | LENOVOLJ-2000/2000PRO/ | 800 g | 100 g | 8 |
| | 2000L/2050N/2200/2200L2250/ | | | |
| | 2250N/M3020/M3120/ | | | |
| | M3220/M7020/M7020PRO/ | | | |
| | M7030/M7120/M7120PRO/ | | | |
| | M7130N/M7205?M7215/M7250/ | | | |
| | M7250N/M7260 | | | |
| KDM-01 | SAMSUNGML-1510/1710/1740/ | 800 g | 80 g | 10 |
| | 1750; SCX-4016/4116/4216F/ | | | |
| | 4100/4200/4300; SF-560/ | | | |
| | 565P/560R/560RC/565PR/565PRC | | | |
| KDM-01 | Xerox | 800 g | 80 g | 10 |
| | Phaser3116/3115/3120/3121 | | | |
| | 3130; WorkCentre | | | |
| | PE16/3119; Lexmark X215 | | | |
| | MFP; Toshiba e-STUDIO | | | |
| | 180s | | | |

1. A multifunctional ink powder filling device for regenerated powder cartridge box, comprising:
a bottle body;
a powder-leakage prevention bottle plug; and
a powder filling nozzle and a bottle cover serving as a measuring cup at the same time;
wherein the bottle plug is tightly matched and arranged on a bottle mouth of the bottle body and is externally provided with powder filling nozzle, the upper end of the powder filling nozzle is provided with a diminishing heavy-caliber powder filling hopper and the powder filling nozzle is externally provided with the bottle cover.

2. The multifunctional ink powder filling device for regenerated powder cartridge box according to claim 1, wherein the inner and the outer peripheries of the pedestal of the powder filling nozzle are respectively provided with inner threads matched with the outer threads of the bottle mouth and outer threads matched with the inner threads on the mouth part of the bottle cover.

3. The multifunctional ink powder filling device for regenerated powder cartridge box according to claim 1, wherein a light-caliber powder filling hopper is plugged in or connected through threads with the heavy-caliber powder filling hopper so as to be adapted to the needs of different powder filling nozzles of powder cartridge boxes.

4. The multifunctional ink powder filling device for regenerated powder cartridge box according to claim 1, wherein the bottle cover is provided with scales serving as a measuring cup which can quantitatively measure the amount of the filled powder for different powder cartridge boxes at the time of powder filling.

5. The multifunctional ink powder filling device for regenerated powder cartridge box according to claim 1, wherein diminishing steps are provided on top of the inner threads on the mouth part of the bottle cover to be tightly impacted on the shoulders of the pedestal of the powder filling nozzle.

6. The multifunctional ink powder filling device for regenerated powder cartridge box according to claim 1, wherein the powder filling amount of the bottle body is 7˜10 times of the amount of the powder needed by general powder cartridge box, and can be used for powder filling of many powder cartridge boxes of the same type or powder cartridge boxes of different types but use ink powder with the same standard.

7. The multifunctional ink powder filling device for regenerated powder cartridge box according to claim 1, wherein the bottle plug comprises cylindric upright side and bottom, wherein the upper end of the cylindric upright side is provided with external protruding edge, the outer peripheries of the cylindric upright side are provided with several sealed protruding rings around the circle and tightly matched with the inner side of the bottle mouth.

8. The multifunctional ink powder filling device for regenerated powder cartridge box according to claim 1, wherein the waist part of the bottle body is provided with grooves to be convenient for holding.
